(19) United States
(12) Patent Application Publication
(10) Pub. No.: US 2006/0258242 A1
(43) Pub. Date: Nov. 16, 2006

(54) Method for providing a detergent-free washing function and fiber product capable of washing without using a detergent

(76) Inventors: Shoichi Hirano, Kyoto (JP); Yoshinari Yui, Kunma (JP); Kazuhito Ozaki, Kyoto (JP); Ozawa Nanami, Osaka (JP); Shingo Akjeda, Kyoto (JP); Shinobu Tabata, Hyogo (JP); Susumu Kibune, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/564,091

(22) PCT Filed: May 21, 2004
(86) PCT No.: PCT/JP04/06969

§ 371 Date: Jun. 20, 2006

(30) Foreign Application Priority Data
Jul. 14, 2003 (JP) 2003-274274

(51) Int. Cl. C11D 3/00; D06M 23/00; B32B 27/04

(52) U.S. Cl. 442/118; 8/115.51; 8/116.1; 8/137

(57) ABSTRACT

It is an object of the present invention to provide a method for providing detergent-free washing function by which a washing effect approximately same as that in the case of using a detergent can be caused even in the case of washing a fiber or a fiber product without using a detergent and a fiber product capable of washing without using a detergent. The present invention relates to a method for providing a detergent-free washing function to a fiber or a fiber product, which is subjected to hydrophilization treatment.

### TECHNICAL FIELD

The present invention relates to: a method for providing detergent-free washing function by which a washing effect approximately same as that in the case of using a detergent can be caused even in the case of washing a fiber or a fiber product without using a detergent, and a fiber product capable of washing without using a detergent.

### BACKGROUND ART

A stained fiber product is washed by using a detergent in common sense. It is carried out by promoting separation of staining and blotting components from the surface of a fiber on the effect of a surfactant, a main component of a detergent. However, it has been pointed out that environments such as seas, lakes and marshes might be polluted seriously if a large quantity of detergents is discharged to the environments. As countermeasures against the problem, recently the components in detergents have been reconsidered and detergents containing, as main components, those which cause insignificant effects on environments or detergents which might bring same washing effects even in a little amount as those of conventional ones have been developed and commercialized. However, an immense amount of the detergents have been consumed for domestic use and industrial use and discharged and how to solve the adverse effects of the detergents on the environments has still been a serious problem left unsolved.

To deal with the problem, it has been tried to improve washing machines or washing methods so as to develop washing methods achieving similar washing effects without using any detergents to those in the case of using detergents. For example, Patent Document No. 1 discloses a washing method for having the same washing effect as detergents without using any detergents containing hydronium ions, hydroxyl ions and the like by passing a mixture of water and air via clothes at a high speed. However, this method requires a special washing machine and there are reports that the washing effects are insufficient to the stains and dirt derived from oily components such as sebaceous matters.

[Patent Document No. 1] Japanese Kokai Publication 2000-237485

### DISCLOSURE OF THE INVENTION

### Problems which the Invention is to Solve

In consideration of the above-mentioned present situation, the present invention aims to provide a method for providing detergent-free washing function by which a washing effect approximately same as that in the case of using a detergent can be caused even in the case of washing a fiber or a fiber product without using a detergent and a fiber product capable of washing without using a detergent.

### Means for Solving the Problems

Hereinafter the present invention will be described in details.

Incidentally, in this description, the fiber products include clothes such as underwear, overcoats, socks, panty hoses, globes, hats and caps, hair bands, neckties, and all other common products containing fibers such as handkerchiefs, towels, face masks, mufflers, sheets, pillow covers, Futon, cushions, diapers, diaper covers and the like.

Based on the results of the enthusiastic investigations, inventors of the present invention have unexpectedly found it possible to provide a detergent-free washing function by subjecting fibers or fiber products to hydrophilization treatment and consequently have accomplished the present invention. It is supposedly attributed to that since almost all of stains and dirt to be concerned for the fibers or fiber products are oily components such as sebaceous matters, the bonding force of the components of stains and dirt to the fibers is weakened by hydrophilization of the fibers or the fiber products and accordingly, the staining and blotting components can be separated only by water even without using a surfactant. With respect to stains other than the oily components, if washing is carried out by using a large quantity of water, they can be separated without using a surfactant.

In this description, the detergent-free washing function means to cause an approximately same washing effect even in the case of washing without using a detergent as that in the case of washing with using a detergent; and that the approximately same washing effect is caused means that the washing effect in the case fibers or fiber products subjected to hydrophilization treatment by the method for providing the detergent-free washing function of the present invention are washed without using a detergent is same as the washing effect in the case untreated fibers or fiber products are washed by using a detergent. Practically, for example, it means that in the case object fibers or fiber products are white, the alteration of the whiteness after the fibers or fiber products, which are subjected to the hydrophilization treatment by the method for providing the detergent-free washing function of the present invention, are stained and blotted and washed without using a detergent from that before the fibers or the fiber products are stained and blotted is within 110% to the alteration of the whiteness after untreated fibers or fiber products are stained and blotted and washed using a detergent from that before the fibers or the fiber products are stained and blotted. Also, it means that in the case the object fibers or fiber products are colored including white color, the remaining ratio (%) of oleic acid after the fibers or fiber products, which are subjected to the hydrophilization treatment by the method for providing the detergent-free washing function of the present invention, are stained with oleic acid 10% owf and gelatin 2.5% owf and washed without using a detergent is within 110% to the remaining ratio (%) of the oleic acid after untreated fibers or fiber products are stained with oleic acid 10% owf and gelatin 2.5% owf and washed using a detergent.

The above-mentioned hydrophilization treatment is not particularly limited and it is preferable to carry out the hydrophilization treatment by at least one method selected from a group consisting of, for example, a method for introducing a hydrophilic group, a method for introducing a hydrophilic molecule, a method for improving the surface physically, and a method for applying a coating agent containing a hydrophilic substance.

The above-mentioned method for introducing a hydrophilic group is not particularly limited and a method for directly bonding a hydrophilic group, e.g. a polar group such as a carboxyl group, an amino group, a sulfone group, a hydroxyl group, a phosphoric acid group, an epoxy group, and an ether residual group, or groups comprising these groups to the molecules composing the fibers or fiber products can be exemplified.

The above-mentioned method for introducing a hydrophilic molecule is not particularly limited and examples of the method are a method for bonding a molecule comprising a hydrophilic group, e.g. a polar group such as a carboxyl group, an amino group, and a sulfone group, or groups comprising these groups to the molecules composing the fibers or fiber products and a method for bonding side chains with high hydrophilicity to the fibers or fiber products by graft polymerization of methacrylamide, hydroxyethyl acrylate, acrylic acid, methacrylic acid or the like. The method is particularly suitable in the case the fibers or fiber products are of cellulose type, polyethylene terephthalate, nylon and the like.

The above-mentioned method for improving the surface physically is not particularly limited and examples of the method are methods for surface-treating the fibers or fiber products with plasma treatment, corona treatment; ionizing and activating beam treatment with UV rays, electron beam, radiation beam, and laser; flame treatment, ozonization, treatment with enzymes or microorganism, and the like.

The above-mentioned method for applying a coating agent containing a hydrophilic substance is not particularly limited and an example of the method is forming a coating on the surface of the fibers or fiber products by using coating agents obtained by dissolving hydrophilic substances such as hydrophilic vinyl compounds, polyalkylene oxide type compounds, and hydrophilic natural compounds in binder resins such as acrylic resin, methacrylic resin, urethane resin, silicon resin, glyoxal resin, vinyl acetate resin, vinylidene chloride resin, butadiene resin, melamine resin, epoxy resin, acryl-silicon copolymer resin, ethylene-vinyl acetate copolymer resin, isobutylene-maleic anhydride copolymer resin. Also, the coating may be formed by applying these monomers or oligomers and then making them resins by reaction.

The fibers or fiber products to be objects of the method for providing the detergent-free washing function of the present invention are not particularly limited and those made of natural fibers such as cellulose type fibers (cotton), flax, silk, and wool; synthetic fibers such as polyethylene terephthalate, rayon, polynosic, cupra, acetate, nylon, vinylon, vinylidene, poly(vinyl chloride), acryl, acrylic type, polyethylene, polypropylene, polyurethane, and their blended fibers. Among them, those containing at least cellulose type fibers are preferable since the cellulose type fibers are used for many fiber products such as underwear.

Hereinafter, the method for providing the detergent-free washing function of the present invention will be described more in details in the case the fibers or fiber products containing at least cellulose type fibers. If the fibers or fiber products containing at least cellulose type fibers are blended fibers of cellulose type fibers and other fibers, the following hydrophilization treatment may be carried out in the blended fiber state or the hydrophilization treatment may be carried out only for the cellulose type fibers and then the fibers are blended with other fibers.

With respect to the method for providing the detergent-free washing function of the present invention, in the case that the above-mentioned fibers or fiber products contain at least the cellulose type fibers, the moisture absorption ratio of the cellulose type fibers is preferably adjusted to be 7.1% or higher by the hydrophilization treatment. If it is lower than 7.1%, the bonding force of the oily staining and blotting components to the fibers or fiber products is so high that the staining and blotting components cannot be removed sufficiently only by water in some cases. It is more preferably 7.5% or higher. The moisture absorption ratio is not particularly limited in the upper limit and generally it is preferably 20%, more preferably 15%.

The above-mentioned moisture absorption ratio can be calculated according to the following equation (1)

[Equation (1)]
Moisture absorption ratio (%)=([official weight]÷[bone-dry weight]−1)×100 (1)

In the above-mentioned equation (1), the bone-dry weight can be calculated, for example, by measuring the weight of an object fiber or fiber product to be measured and a weighing bottle after the object fiber or fiber product is put in the weighing bottle and dried at 105° C. for 2 hours and subtracting the previously measured weight of the weighing bottle from the weight of the fiber or fiber product and the weighing bottle. The official weight can be calculated, for example, by measuring the weight of the fiber or fiber product whose bone-dry weight is measured in the weighing bottle and the weighing bottle after they are left in atmosphere at 20° C. and 65% RH for 24 hours and subtracting the weight of the weighing bottle from the weight of the fiber or fiber product and the weighing bottle. For the measurement of the bone-dry weight and the official weight, for example, a small cloth specimen with a size of about 10×20 cm can be used. The weight measurement is repeated until the weight is stabilized.

The hydrophilization treatment method in the case the fibers or fiber products contain at least cellulose type fibers is not particularly limited and since it can give high moisture absorption ratio relatively easily, a method for introducing a carboxyl group is preferable. In this description, a carboxyl group includes salts such as sodium salt and potassium salt.

One preferable embodiment of the method for introducing a carboxyl group into the above-mentioned cellulose type fibers will be described. A carboxyl group may be introduced into cellulose type fibers easily in form of carboxymethyl by, for example, bringing a treatment solution containing monochloroacetic acid or a monochloroacetic acid alkali metal salt (e.g. sodium salt, potassium salt) into contact with the cellulose type fibers. Hereinafter, such introduction of a carboxymethyl group in such a method is referred to as carboxymethylation.

In the case of the above-mentioned carboxymethylation, the concentration of the monochloroacetic acid or the monochloroacetic acid alkali metal salt in the treatment solution may properly be determined so as to achieve aimed processing degree and it is preferably 10 to 500 g/L, more preferably 50 to 300 g/L, and even more preferably 100 to 200 g/L.

In the case of the above-mentioned carboxymethylation, the treatment solution preferably contains an alkali metal hydroxide, e.g. sodium hydroxide. Addition of sodium hydroxide makes it possible to improve carboxymethylation degree of the treated fibers to be obtained. The reaction degree tends to be increased more as the concentration of sodium hydroxide is increased in the above-mentioned treatment solution and the concentration of the sodium hydroxide is preferably 20 g/L or higher. However if a large quantity of sodium hydroxide is added, the touch of fibers to be obtained tends to be deteriorated, and therefore, it should be selected carefully.

As the method for bringing the above-mentioned treatment solution into contact with the cellulose type fibers, for example, a solution flowing method for swirling the fibers in the treatment solution; a method for immersing fibers in the treatment solution and then padding (squeezing) the fibers can be exemplified. In terms of the utilization efficiency, it is effective to decrease the bath ratio (the use ratio of the treatment solution) and from this viewpoint, the method for immersing and then padding the fibers is efficient. The temperature condition in the case of bringing the treatment solution into contact with the cellulose type fibers is not particularly limited and it is preferable to be, for example, in a range of 5 to 50° C.

The duration for bringing the above-mentioned treatment solution into contact with the cellulose type fibers may properly be selected depending on various conditions such as the aimed carboxymethylation degree, the concentration of monochloroacetic acid in the treatment solution, the concentration of sodium hydroxide and the like. The contact may be carried out at a normal temperature for several hours to several days or the time needed for the contact may be shortened by heating treatment.

In the case of clothes such as underwear or those required particularly to have good touch, it is preferable to adjust the concentration of monochloroacetic acid or monochloroacetic acid alkali metal salt in the treatment solution, the concentration of the alkali metal hydroxide in the treatment solution, the treatment temperature, and the treatment duration. Among them, if the concentration of the alkali metal hydroxide in the treatment solution is increased, cellulose type fibers tend to be damaged, resulting in hard touch. Accordingly, it is preferable to lower the concentration of the alkali metal hydroxide in the treatment solution as much as possible and to lower the treatment temperature so as to suppress the effect of the alkali metal hydroxide. On the other hand, in order to achieve a sufficient carboxymethylation degree even in the state that the concentration of the alkali metal hydroxide is suppressed to low, it is required to set the concentration of monochloroacetic acid or the monochloroacetic acid alkali metal salt in the treatment solution to be relatively high and to prolong the treatment duration. Practically, in the case where the cellulose type fibers is brought into contact with the treatment solution containing an alkali metal hydroxide in the concentration of 20 to 100 g/L, monochloroacetic acid or the monochloroacetic acid alkali metal salt in the concentration of 100 to 400 g/L at 10 to 40° C. for 6 to 48 hours, both of the sufficient moisture absorption ratio and the good touch can be satisfied.

The lower limit of the above-mentioned carboxymethylation degree is preferably 0.1% by mole. If it is less than 0.1% by mole, sufficient moisture adsorption degree cannot be achieved in some cases. The lower limit is more preferably 1% by mole. The upper limit of the carboxymethylation degree is not particularly limited, however it is preferably 10% by mole, more preferably 5% by mole.

In this description, carboxymethylation degree is the ratio (%) of carboxymethylated hydroxyl of the cellulose, which is the ratio (%) of the number of COO groups after the carboxymethylation to the number of hydroxyl groups of untreated cellulose. The number of COO group in the cellulose type fibers can be calculated by quantitatively determining Na consumed for the replacement after the entire COO groups of the cellulose type fibers is converted into COOH groups and then the resulting fibers are immersed in an aqueous sodium hydroxide solution (0.1 N). The quantity of Na consumed for the replacement can quantitatively be measured by titrating, for example, hydrochloric acid (0.1 N) to the aqueous sodium hydroxide solution used for immersion of the treated fiber or fiber product. More particularly, the following measurement method can be employed.

At first a treated cellulose type fiber (e.g. a small cloth specimen) is immersed in 0.3 N hydrochloric acid in the conditions of bath ratio 1:50 and the solution temperature 20° C. for 1 hour to convert the entire COO groups into COOH groups, dewatered, and dried and then the remaining HCl is removed and about 4 g of the specimen is sampled and its bone-dry weight (W (g)) is weighed. Next, the cellulose fiber whose bone-dry weight is weighed is immersed in an aqueous solution of 0.1N sodium hydroxide 50 mL (B (mL)) and left at 20° C. overnight to replace the entire COOH groups to COONa. Further, to quantitatively measure Na consumed for the replacement, 0.1 N hydrochloric acid is titrated to the solution and the titration value is defined to be X (mL). Phenolphthalein may be used as an indicator.

The carboxymethylation degree can be calculated according to the following equation (2) from the bone-dry weight (W (g)) of the cellulose type fiber; the volume (B (mL)) of the aqueous sodium hydroxide solution; and the volume (X (mL)) of hydrochloric acid used for the titration.

[Equation 2]
Carboxymethylation degree (% by mole)=162.14×(B−X)÷[10,000 W−59.04×(B−X)]÷3×100 (2)

As a method for the hydrophilization treatment in the case the fibers or fiber products contain at least cellulose type fibers, a method for graft polymerizing of at least one kind of monomer selected from a group consisting of methacrylamide, hydroxyethyl acrylate, acrylic acid, and methacrylic acid is also preferable.

As a method for the above-mentioned grafting, for example, a method for polymerization in the state that the above-mentioned monomer is brought into contact with the cellulose type fibers can be exemplified. More particularly, for example, the cellulose type fibers are immersed in a solution containing the above-mentioned monomer and a polymerization initiator (e.g. ammonium peroxodisulfate) and then squeezed and heated to obtain cellulose type fibers to which hydrophilic molecules are grafted.

The amount of the hydrophilic molecules to be introduced by the above-mentioned grafting may properly be selected in consideration of the types of the hydrophilic molecules and the moisture absorption ratio required for the cellulose type fibers, and the lower limit of the grafting ratio is preferably 1%. If it is less than 1%, a sufficient moisture absorption ratio cannot be obtained in some cases. The lower limit is more preferably 2%. The upper limit of the grafting ratio is not particularly limited, however it is preferably 30%, more preferably 25%, and even more preferably 20%.

In this description, the grafting ratio can be calculated according to the following equation (3) from the bone-dry weight of the cellulose type fibers before grafting (the bone-dry weight before treatment) and the bone-dry weight of the cellulose type fibers after grafting (the bone-dry weight after treatment).

[Equation (3)]
Grafting ratio (%)=([the bone-dry weight after treatment]÷[the bone-dry weight before treatment]−1)×100 (3)
In the equation (3), the bone-dry weight can be calculated, for example, by measuring the weight of a small cloth specimen with a size about 10×20 cm and a weighing bottle after it is put in the weighing bottle and dried at 105° C. for 2 hours, and subtracting the previously measured weight of the weighing bottle from the measured weight of the specimen and the weighing bottle.

According to the method for providing detergent-free washing function of the present invention to fiber products, even if fibers or fiber products are washed without using a detergent, a function of giving an approximately same effect of washing as that of using a detergent can be provided. Further, in the case of washing without using a detergent, the process (rinsing process) for removing a detergent can be omitted and thus the washing can be completed in a short time. Owing to such shortening of the washing time, consumption of resources such as water and electric power can considerably be saved. Further, the fiber products subjected to the method for providing the detergent-free washing function of the present invention are also provided with secondary advantageous effects that the moisture absorption-emission property becomes remarkably excellent and that the products give comfortable feeling when they are put on.

The present invention also includes fiber products capable of washing without using a detergent, which contains a fiber subjected to hydrophilization treatment.

In this description, that capable of washing without using a detergent means to cause an approximately same washing effect even in the case of washing without using a detergent as that in the case of washing with using a detergent, and that the approximately same washing effect is caused means that the washing effect in the case fiber products capable of washing without using a detergent of the present invention are washed without using a detergent is same as the washing effect in the case common fiber products are washed by using a detergent. Practically, it means the same effect of the detergent-free washing function as described above.

The fiber products of the present invention capable of washing without using a detergent contain fibers subjected to the hydrophilization treatment. The above-mentioned hydrophilization treatment is not particularly limited and at least one method selected from a group consisting of a method for introducing a hydrophilic group, a method for introducing a hydrophilic molecule, a method for improving the surface physically, and a method for applying a coating agent containing a hydrophilic substance. The practical examples of the respective treatment methods are same as described above in the method for providing the detergent-free washing function.

The fibers subjected to the above-mentioned hydrophilization treatment are not particularly limited and may include those obtained by hydrophilization treatment of natural fibers such as cellulose type fibers (cotton), flax, silk, and wool; synthetic fibers such as polyethylene terephthalate, rayon, polynosic, cupra, acetate, nylon, vinylon, vinylidene, poly(vinyl chloride), acryl, acrylic type, polyethylene, polypropylene, polyurethane; and their blended fibers. Among them, those containing at least cellulose type fibers subjected to the hydrophilization treatment are preferable since the cellulose type fibers are used for many fiber products such as underwear.

In the case the fiber products of the present invention capable of washing without using a detergent contain the cellulose type fibers subjected to the hydrophilization treatment, the above-mentioned cellulose type fibers subjected to the hydrophilization treatment are preferable to have a moisture absorption ratio 7.1% or higher. If it is less than 7.1%, the bonding force of the oily staining and blotting components and the fibers is so high that the staining and blotting components cannot be removed sufficiently only by water in some cases. It is more preferably 7.5% or higher. The moisture absorption ratio is not particularly limited in the upper limit and generally it is preferably 20%, more preferably 15%.

As the above-mentioned cellulose type fibers subjected to the hydrophilization treatment, for example, carboxymethylated cellulose type fibers are preferable. Especially, in the case the touch is required, carboxymethylated cellulose type fibers obtained by bringing the cellulose type fibers into contact with a treatment solution containing an alkali metal hydroxide in a concentration of 20 to 100 g/L and monochloroacetic acid or a monochloroacetic acid alkali metal salt in a concentration of 100 to 400 g/L at 10 to 40° C. for 6 to 48 hours are preferable. In this case, the carboxymethylation degree is preferably 0.1 to 10% by mole.

As the above-mentioned cellulose type fibers subjected to hydrophilization treatment, cellulose type fibers grafted by at least one kind of monomer selected from a group consisting of methacrylamide, hydroxyethyl acrylate, acrylic acid, and methacrylic acid are also preferable. In this case, the grafted cellulose fiber preferably has a grafting ratio of 1 to 20%.

The fiber products of the present invention capable of washing without using a detergent may further contain deodorants. In the case a carboxyl group is introduced as the hydrophilization treatment, a high deodorization effect is provided and addition of the deodorants further improves the deodorization effect.

The above-mentioned deodorants are not particularly limited and for example, conventional ones such as zinc oxide type, titanium oxide type, silver type, zeolite type, and plant extract type can be used. Among them, zinc oxide type deodorants are preferable for use since they are easy to be processed to fibers.

Since the fiber products of the present invention capable of washing without using a detergent have the above-mentioned constitution, even if they are washed without using a detergent, an approximately same washing effect as that in the case of washing using a detergent can be achieved. Further, in the case the fiber products of the present invention capable of washing without using a detergent are washed without using a detergent, the process (rinsing process) for removing a detergent can be omitted and thus the washing can be completed in a short time. Owing to such shortening of the washing time, consumption of resources such as water and electric power can considerably be saved. Further, the fiber products of the present invention capable of washing without using a detergent are also excellent remarkably in the moisture absorption-emission property and comfortable feeling when they are put on.

### EFFECT OF THE INVENTION

The present invention provides a method for providing detergent-free washing function by which a washing effect approximately same as that in the case of using a detergent can be caused even in the case of washing a fiber or a fiber product without using a detergent, and a fiber product capable of washing without using a detergent.

### BEST MODE FOR CARRYING OUT THE INVENTION

Hereinafter, the present invention will be described in details with reference to Examples, however the present invention is not limited to these examples.

### EXAMPLE 1

As an original cloth, common cotton cloth was used and it was immersed in a treatment solution containing sodium monochloroacetate (200 g/L) and sodium hydroxide (70 g/L) at a bath ratio of 1:20, squeezed by a padder, and then kept at 25° C. for 24 hours for promoting reaction. The unreacted matters were removed by washing with water and the resulting cotton cloth was dried to obtain treated cloth.

The treated cloth was found carboxymethylated at 2.67 carboxymethylation degree and having a moisture absorption ratio of 8.9% by respective measurements.

### EXAMPLE 2

As an original cloth, common cotton cloth was used and it was immersed in an aqueous solution containing methacrylic acid monomer 150 g/L and ammonium peroxodisulfate 7.5 g/L at 20° C. for 1 minute, squeezed by a padder, and steamed at 100° C. for 10 minutes, and after that the unreacted matters were removed by washing with water and the resulting cotton cloth was dried to obtain treated cloth.

The treated cloth was found having a grafting ratio of 2.1% and a moisture absorption ratio of 7.8% by respective measurements.

### EXAMPLE 3

As an original cloth, common cotton cloth which was dyed to 1.0% owf by using a reactive dye (Smifix Supra: manufactured by Sumitomo Chemical Co., Ltd.) was used and it was immersed in a treatment solution containing sodium monochloroacetate (200 g/L) and sodium hydroxide (70 g/L) at a bath ratio of 1:20, squeezed by a padder, and then kept at 25° C. for 24 hours for promoting reaction. The unreacted matters were removed by washing with water and the resulting cotton cloth was dried to obtain treated cloth.

The treated cloth was found having a moisture absorption ratio of 8.4% by measurement.

### EXAMPLE 4

As an original cloth, a cloth made of cotton-polyethylene terephthlate mixed fibers containing 64% by weight of cotton and 36% by weight of polyethylene terephthalate was used and it was immersed in a treatment solution containing sodium monochloroacetate (250 g/L) and sodium hydroxide (70 g/L) at a bath ratio of 1:28, squeezed by a padder, and then kept at 25° C. for 24 hours for promoting reaction. The unreacted matters were removed by washing with water and the resulting cloth was dried to obtain treated cloth.

The cotton portion of the treated cloth was found carboxymethylated at 2.85 carboxymethylation degree and having a moisture absorption ratio of 8.9% by respective measurements.

### EXAMPLE 5

As an original cloth, common cotton cloth was used and it was immersed in a treatment solution containing sodium monochloroacetate (200 g/L) and sodium hydroxide (70 g/L) at a bath ratio of 1:20, squeezed by a padder, and then kept at 100° C. for 5 minutes for promoting reaction. The unreacted matters were removed by washing with water and the resulting cotton cloth was dried to obtain treated cloth.

The treated cloth was found carboxymethylated at 2.58 carboxymethylation degree and having a moisture absorption ratio of 8.7% by respective measurements.

### EXAMPLE 6

As an original cloth, common cotton cloth was used and it was immersed in a treatment solution containing sodium monochloroacetate (200 g/L) and sodium hydroxide (100 g/L) at a bath ratio of 1:20, squeezed by a padder, and then kept at 25° C. for 24 hours for promoting reaction. The unreacted matters were removed by washing with water and the resulting cotton cloth was dried to obtain treated cloth.

The treated cloth was found carboxymethylated at 3.83 carboxymethylation degree and having a moisture absorption ratio of 11.1% by respective measurements.

### EXAMPLE 7

As an original cloth, common cotton cloth was used and it was immersed in a treatment solution containing sodium monochloroacetate (50 g/L) and sodium hydroxide (150 g/L) at a bath ratio of 1:20, squeezed by a padder, and then kept at 100° C. for 5 minutes for promoting reaction. The unreacted matters were removed by washing with water and the resulting cotton cloth was dried to obtain treated cloth.

The treated cloth was found carboxymethylated at 2.63 carboxymethylation degree and having a moisture absorption ratio of 8.8% by respective measurements.

### REFERENCE EXAMPLE

As a reference cloth, cotton cloth (an original cloth) used in Examples was used. The moisture absorption ratio of the cotton cloth was 7.0%.

(Evaluation)

The treated cloths of Examples 1 to 7 and the reference cloth were subjected to a test of washability to oleic acid, a test of repeat washing, and a test of deodorization effect by the following methods.

The results are shown in Table 1.

(1) Test of Washability to Oleic Acid

After each cloth specimen was stained with oleic acid 10% owf and gelatin 2.5% owf and washed by a common domestic washing machine (ES-S4A, manufactured by Sharp Corp.) in both cases of only with water and using a detergent (Attack, manufactured by Kao Corp.) in a concentration of 0.67 g/L. After each washed cloth specimen was sun-dried, the oleic acid remaining on the cloth specimen was extracted by methanol and the amount of the remaining oleic acid was measured by gas chromatography (GC-17A, manufactured by Shimadzu Corp.) to calculate the oleic acid remaining ratio (%). Based on the calculated oleic acid remaining ratio (%), the evaluation was carried out according to the following criteria:
⊚: the oleic acid remaining ratio (%) in the case of washing only by water was not higher than 80%. of the oleic acid remaining ratio (%) in the case of washing the reference cloth using a detergent:
◯: the oleic acid remaining ratio (%) in the case of washing only by water was not higher than 110% of the oleic acid remaining ratio (%) in the case of washing the reference cloth using a detergent:
Δ: the oleic acid remaining ratio (%) in the case of washing only by water was not higher than 120% of the oleic acid remaining ratio (%) in the case of washing the reference cloth using a detergent: and
×: the oleic acid remaining ratio (%) in the case of washing only by water exceeded 120% of the oleic acid remaining ratio (%) in the case of washing the reference cloth using a detergent.
   (2) Test of Repeat Washing

After each cloth specimen was immersed in artificial sweat mainly containing oleic acid 40.6%, triolein 22.4%, cholesterol oleate 17.5%, liquid paraffin 3.6%, cholesterol 2.3%, and gelatin 10.0% at a bath ratio 1:30, squeezed at 130% squeezing and dried at 105° C. for 30 minutes.

The each specimen was washed by a common domestic washing machine (ES-S4A, manufactured by Sharp Corp.) in both cases of only with water and using a detergent (Attack, manufactured by Kao Corp.) in a concentration of 0.67 g/L. After each washed cloth specimen was sun-dried. The process was repeated 3 times and whiteness alteration was investigated for each specimen in the respective cases. The measurement of the whiteness was carried out using a color measuring apparatus (White Eye 3000, manufactured by Gretag-Macbeth Ltd.). The alteration of the whiteness of the cloth specimens before and after the test was calculated and evaluation was carried out according to the following criteria:
⊚: the alteration of the whiteness in the case of washing only by water was not higher than 80% of the alteration of the whiteness in the case of washing the reference cloth using a detergent:
◯: the alteration of the whiteness in the case of washing only by water was not higher than 100% of the alteration of the whiteness in the case of washing the reference cloth using a detergent:
Δ: the alteration of the whiteness in the case of washing only by water was not higher than 120% of the alteration of the whiteness in the case of washing the reference cloth using a detergent: and
×: the alteration of the whiteness in the case of washing only by water exceeded 120% of the alteration of the whiteness in the case of washing the reference cloth using a detergent.
   (3) Test of Deodorization Effect

A magnetic stirrer was put in a 500 mL (practical capacity 625 mL) Erlenmeyer flask and each cloth specimen cut in a size of 4 cm×5 cm was hung in the Erlenmeyer flask by attaching a thread to the specimen and sticking an end of the thread to the outside of the Erlenmeyer flask with a cellophane tape. After that, in the case of ammonia deodorization, a 2% ammonia solution or in the case of acetic acid deodorization, a 3% acetic acid solution was dropwise added along the inner wall face of the Erlenmeyer flask by a 5 μL micro-pipette. The Erlenmeyer flask was plugged quickly with a silicon plug covered with a wrap double and further the wrap was air-tightly covered with a triple-folded rubber band. After that, while being stirred by the magnetic stirrer, the specimen was left at 20° C. for 120 minutes.

After 120 minute-treatment, the silicon plug was unplugged without being separated from the wrap and the gas concentration in the Erlenmeyer flask was measured by using a detector equipped with a silicon plug for measurement (No. 3 La for ammonia: manufactured by Gastec Corp.; No. 81 for acetic acid: manufactured by Gastec Corp.).

The same test was carried out in such a manner that no cloth specimen was hung in the Erlenmeyer flask and the result was employed as a blank measurement value. The deodorization ratio (%) was calculated according to the following equation and evaluation was carried out according to the following criteria.

[Equation 4]
Deodorization ratio (%)={(blank measurement value−cloth specimen measurement value)/blank measurement value}×100
(Ammonia Deodorization)
◯: the deodorization ratio not lower than 70%;
Δ: the deodorization ratio not lower than 50% and lower than 70%; and
×: the deodorization ratio lower than 50%.
   (Acetic Acid Deodorization)
◯: the deodorization ratio not lower than 85%;
Δ: the deodorization ratio not lower than 75% and lower than 85%; and
×: the deodorization ratio lower than 75%.
   (4) Evaluation of Touch

A sensory test was carried out using the reference cloth as a standard and the evaluation was carried out according to the following criteria.
⊚: soft approximately as same as the reference cloth;
◯: slightly hard as compared with the reference cloth, however soft enough; and

×: apparently hard as compared with the reference cloth and unsuitable for underwear.

TABLE 1

| | | | | | test of repeat washing | | | | | |
|---|---|---|---|---|---|---|---|---|---|---|
| | moisture | test of washability to oleic acid | | | alteration of whiteness | | | | | |
| | absorption | remaining ratio(%) | | | before and after test | | | test of | | |
| | ratio(cotton | only with | using | | only with | using | | deodorization effect | | |
| | portion)(%) | water | detergent | evaluation | water | detergent | evaluation | ammonia | acetic acid | touch |
| Example 1 | 8.9 | 31 | 20 | ⊚ | 9.3 | 4.6 | ⊚ | ◯ | ◯ | ⊚ |
| Example 2 | 7.8 | 42 | 33 | ◯ | 11.9 | 6.3 | ◯ | Δ | Δ | ◯ |
| Example 3 | 8.4 | 39 | 25 | ◯ | — | — | — | ◯ | ◯ | ⊚ |
| Example 4 | 9.1 | 40 | 23 | ◯ | 9.6 | 5.4 | ⊚ | ◯ | ◯ | ⊚ |
| Example 5 | 8.7 | 34 | 22 | ◯ | 10.5 | 5.5 | ◯ | ◯ | ◯ | ◯ |
| Example 6 | 11.1 | 10 | 5 | ⊚ | 1.6 | 0.5 | ⊚ | ◯ | ◯ | ◯ |
| Example 7 | 8.8 | 33 | 22 | ⊚ | 10.0 | 5.2 | ⊚ | ◯ | ◯ | X |
| Reference | 7.0 | 78 | 41 | X | 17.6 | 12.4 | X | X | X | — |
| Example | | | | | | | | | | |

### INDUSTRIAL APPLICABILITY OF THE INVENTION

The present invention provides a method for providing detergent-free washing function by which a washing effect approximately same as that in the case of using a detergent can be caused even in the case of washing a fiber or a fiber product without using a detergent, and a fiber product capable of washing without using a detergent.

1. A method for providing a detergent-free washing function,
which comprises subjecting a fiber or a fiber product to hydrophilization treatment.

2. The method for providing a detergent-free washing function according to claim 1,
wherein the hydrophilization treatment is carried out by at least one method selected from a group consisting of a method for introducing a hydrophilic group, a method for introducing a hydrophilic molecule, a method for improving the surface physically, and a method for applying a coating agent containing a hydrophilic substance.

3. The method for providing a detergent-free washing function according to claim 1,
wherein the fiber or fiber product contains at least a cellulose fiber, and the moisture absorption ratio of the cellulose fiber is adjusted to be 7.1% or higher by the hydrophilization treatment.

4. The method for providing a detergent-free washing function according to claim 3,
wherein a carboxyl group is introduced into the cellulose fiber by carboxymethylation.

5. The method for providing a detergent-free washing function according to claim 4,
wherein the cellulose fiber is brought into contact with a treatment solution containing an alkali metal hydroxide in a concentration of 20 to 100 g/L, monochloroacetic acid or a monochloroacetic acid alkali metal salt in a concentration of 100 to 400 g/L at 10 to 40° C. for 6 to 48 hours.

6. The method for providing a detergent-free washing function according to claim 4,
wherein the carboxymethylation degree is adjusted to be 0.1 to 10% by mole.

7. The method for providing a detergent-free washing function according to claim 3,
wherein graft polymerization to the cellulose fiber is carried out using at least one kind of monomer selected from a group consisting of methacrylamide, hydroxyethyl acrylate, acrylic acid, and methacrylic acid.

8. The method for providing a detergent-free washing function according to claim 7,
wherein the grafting ratio is adjusted to be 1 to 20%.

9. A fiber product capable of washing without using a detergent,
which contains a fiber subjected to hydrophilization treatment.

10. The fiber product capable of washing without using a detergent according to claim 9,
wherein the hydrophilization treatment is carried out by at least one method selected from a group consisting of a method for introducing a hydrophilic group, a method for introducing a hydrophilic molecule, a method for improving the surface physically, and a method for applying a coating agent containing a hydrophilic substance.

11. The fiber product capable of washing without using a detergent according to claim 9,
wherein the fiber subjected to the hydrophilization treatment is a cellulose fiber having a moisture absorption ratio of 7.1% or higher subjected to the hydrophilization treatment.

12. The fiber product capable of washing without using a detergent according to claim 11,
wherein the cellulose fiber subjected to the hydrophilization treatment is a carboxymethylated cellulose fiber.

13. The fiber product capable of washing without using a detergent according to claim 12,
wherein the cellulose fiber subjected to the hydrophilization treatment is obtainable by bringing a cellulose fiber into contact with a treatment solution containing an alkali metal hydroxide in a concentration of 20 to 100 g/L, monochloroacetic acid or a monochloroacetic acid alkali metal salt in a concentration of 100 to 400 g/L at 10 to 40° C. for 6 to 48 hours.

14. The fiber product capable of washing without using a detergent according to claim 12,
wherein the carboxymethylated cellulose fiber has a carboxymethylation degree of 0.1 to 10% by mole.

15. The fiber product capable of washing without using a detergent according to claim 11,
wherein the cellulose fiber subjected to the hydrophilization treatment is a cellulose fiber grafted by at least one kind of monomer selected from a group consisting of methacrylamide, hydroxyethyl acrylate, acrylic acid, and methacrylic acid.

16. The fiber product capable of washing without using a detergent according to claim 15,
wherein the grafted cellulose fiber has a grafting ratio of 1 to 20%.
